(19) United States
(12) Patent Application Publication
(10) Pub. No.: US 2006/0280986 A1
(43) Pub. Date: Dec. 14, 2006

(54) End capped ion-conductive polymers

(75) Inventor: Jian Ping Chen, Sunnyvale, CA (US)

Correspondence Address: Richard F. Trecartin;Dorsey & Whitney LLP, Intellectual Property Department, 555 California Street, Suite 1000, San Francisco, CA, 94104-1513, US

(73) Assignee: Polyfuel, Inc.

(21) Appl. No.: 11/443,837

(22) Filed: May 30, 2006

Related U.S. Application Data
(60) Provisional application No. 60/685,300, filed on May 27, 2005.

(51) Int. Cl. H01M 8/10; C08J 5/20

(52) U.S. Cl. 429/33; 521/25; 429/317

(57) ABSTRACT

The invention provides end-capped ion-conductive copolymers that can be used to fabricate proton exchange membranes (PEM's), catalyst coated proton exchange membranes (CCM's) and membrane electrode assemblies (MEA's) that are useful in fuel cells and their application in electronic devices, power sources and vehicles.

### CROSS-REFERENCE TO RELATED APPLICATIONS

The present application claims priority to U.S. Provisional Application No. 60/685,300 filed May 27, 2005 which is hereby incorporated by reference in its entirety.

### FIELD OF THE INVENTION

This invention relates to end-capped ion-conductive polymers that are useful in forming polymer electrolyte membranes used in fuel cells.

### BACKGROUND OF THE INVENTION

Fuel cells are promising power sources for portable electronic devices, electric vehicles, and other applications due mainly to their non-polluting nature. Of various fuel cell systems, polymer electrolyte membrane based fuel cells such as direct methanol fuel cells (DMFCs) and hydrogen fuel cells, have attracted significant interest because of their high power density and energy conversion efficiency. The “heart” of a polymer electrolyte membrane based fuel cell is the so called “membrane-electrode assembly” (MEA), which comprises a proton exchange membrane (PEM), catalyst disposed on the opposite surfaces of the PEM to form a catalyst coated membrane (CCM) and a pair of electrodes (i.e., an anode and a cathode) disposed to be in electrical contact with the catalyst layer.

Proton-conducting membranes for DMFCs are known, such as Nafion® from the E.I. Dupont De Nemours and Company or analogous products from Dow Chemical. These perfluorinated hydrocarbon sulfonate ionomer products, however, have serious limitations when used in high temperature fuel cell applications. Nafion® loses conductivity when the operation temperature of the fuel cell is over 80° C. Moreover, Nafion® has a very high methanol crossover rate, which impedes its applications in DMFCs.

U.S. Pat. No. 5,773,480, assigned to Ballard Power System, describes a partially fluorinated proton conducting membrane from α,β,β-trifluorostyrene. One disadvantage of this membrane is its high cost of manufacturing due to the complex synthetic processes for monomer α,β,β-trifluorostyrene and the poor sulfonation ability of poly (α,β,β-trifluorostyrene). Another disadvantage of this membrane is that it is very brittle, thus has to be incorporated into a supporting matrix.

U.S. Pat. Nos. 6,300,381 and 6,194,474 to Kerrres, et al. describe an acid-base binary polymer blend system for proton conducting membranes, wherein the sulfonated poly(ether sulfone) was made by post-sulfonation of the poly (ether sulfone).

M. Ueda in the Journal of Polymer Science, 31(1993): 853, discloses the use of sulfonated monomers to prepare the sulfonated poly(ether sulfone polymers).

U.S. Patent Application US 2002/0091225A1 to McGrath, et al. used this method to prepare sulfonated polysulfone polymers.

Ion conductive block copolymers are disclosed in PCT/US2003/015351.

End-capping of poly (ether sulfones) is described in Muggli, et al., Journal of Polymer Science, 41:2850-2860 (2003).

End-capping of sulfonated poly (ether sulfones) is described in Wang F. et al., Polymer Preprint, 43 492 (2002).

Ion-conducting polymers with identical backbone structures can contain different end groups depending on the stoichiometry of the polymerization reaction. Such ion-conducting copolymers may differ in physical, mechanical, and chemical properties. For example, ion-conducting polyarylene ketones and polyarylene sulfones can be synthesized from the condensation of difluoro or dichloro, and diol or dithiol monomers, in the presence of a base (i.e., K₂CO₃) in a mixture of DMSO and toluene. Based on the stoichiometry, a polymer synthesized from difluoro, diol and dithiol monomers can have chemically reactive halogen, hydroxyl or thiol groups at each of the polymer chain ends or a halogen at one end and hydroxyl or thiol at the other.

### SUMMARY OF THE INVENTION

Ion-conducting copolymers having terminal groups that are chemically reactive may be detrimental to the stability of the ion-conducting copolymer, especially when fabricated as a PEM that is used in a fuel cell. The redox reactions that occur at or near the surface of the PEM, including the generation of free radicals, can result in chemical degradation of the PEM by reactions that occur with the chemically reactive end groups. This can decrease the performance and lifetime of the PEM.

To minimize this problem, at least one of the chemically reactive end groups of the ion-conducting copolymers are end-capped with a chemically inactive monomer or oligomer. Such end-capping can improve not only polymer stability, but also offer better control of the molecular weight of the copolymer. End-capping can also narrow the molecular weight distribution, which can affect water uptake, methanol crossover for direct methanol fuel cells and oxidative stability for hydrogen fuel cells.

The end-capped ion-conducting copolymers are preferably made by combining the end-capping monomer with the monomers and/or oligomers that are polymerized to form the ion-conducting copolymer.

The end-capped ion-conductive copolymers can be used to fabricate polymer electrolyte membranes (PEM's), catalyst coated polymer electrolyte membranes (CCM's) and membrane electrode assemblies (MEA's) that find particular utility in hydrogen fuel cells and direct methanol fuel cells. Such fuel cells can be used in electronic devices, both portable and fixed, power supplies including auxiliary power units (APU's) and as locomotive power for vehicles such as automobiles, aircraft and marine vessels and APU's associated therewith.

### BRIEF DESCRIPTION OF DRAWINGS

FIG. 1 is a polarization curve for Membrane 6 which was made from the ion-conducting copolymer of Example 6.

FIG. 2 is a polarization curve for Membrane 9 which was made from the ion-conducting copolymer of Example 9.

### DETAILED DESCRIPTION OF THE INVENTION

In one aspect, the end-capped ion-conductive copolymers comprise one or more ion-conductive oligomers distributed in a polymeric backbone where the polymeric backbone contains at least one, two or three of the following: (1) one or more ion conductive monomers; (2) one or more non-ionic monomers; and (3) one or more non-ionic oligomers. In addition, the ion conducting copolymers further comprise at least one end-capping monomer covalently linked to an end of the ion-conducting copolymer. The ion-conducting oligomers, ion-conducting monomers, non-ionic monomers and/or non-ionic oligomers and end-capping monomers are covalently linked to each other by oxygen and/or sulfur.

The ion-conducting oligomers comprises first and second comonomers. The first comonomer comprises one or more ion-conducting groups. At least one of the first or second comonomers comprises two leaving groups while the other comonomer comprises two displacement groups. In one embodiment, one of the first or second comonomers is in molar excess as compared to the other so that the oligomer formed by the reaction of the first and second comonomers contains either leaving groups or displacement groups at each end of the ion-conductive oligomer. This precursor ion-conducting oligomer is combined with at least one of: (1) one or more precursor ion-conducting monomers; (2) one or more precursor non-ionic monomers; and (3) one or more precursor non-ionic oligomers (made from non-ionic monomers). A precursor end-capping monomer is added to the reaction mixture to produce the end-capped ion-conducting polymer. The precursor ion-conducting monomers, non-ionic monomers and/or non-ionic oligomers each contain two leaving groups or two displacement groups while the end-capping monomer (“monovalent monomer”) contains one leaving group or one displacement group. The choice of leaving group or displacement group for each of the precursors is chosen so that the precursors combine to form an oxygen and/or sulfur linkage.

Alternatively, the ion-conducting oligomer is not a part of the end-capped ion conductive polymer. In this situation, two or more of the (1) ion conductive monomer; (2) non-ionic monomer; and/or (3) non-ionic oligomers are present in the ion-conducting polymer. When only ion-conducting and non-ionic monomers are present, a random copolymer is formed by appropriate choice of monomers and leaving and displacement groups.

The term “leaving group” (LG) is intended to include those functional moieties that can be displaced by a nucleophilic moiety found, typically, in another monomer. Leaving groups are well recognized in the art and include, for example, halides (chloride, fluoride, iodide, bromide), tosyl, mesyl, etc. In certain embodiments, the monomer has at least two leaving groups. In the preferred polyphenylene embodiments, the leaving groups may be “para” to each other with respect to the aromatic monomer to which they are attached. However, the leaving groups may also be ortho or meta.

The term “displacing group” (DG) is intended to include those functional moieties that can act typically as nucleophiles, thereby displacing a leaving group from a suitable monomer. The monomer with the displacing group is attached, generally covalently, to the monomer that contained the leaving group. In a preferred polyarylene example, fluoride groups from aromatic monomers are displaced by phenoxide, alkoxide or sulfide ions associated with an aromatic monomer. In polyphenylene embodiments, the displacement groups are preferably para to each other. However, the displacing groups may be ortho or meta as well.

End-capping monomers usually have monovalent displacement groups or leaving groups that react with the leaving or replacement groups respectively in the nascent polymer, i.e., they react during the polymerization of the components that form the ion-conducting polymer.

Table 1 sets forth combinations of exemplary leaving groups and displacement groups that can be used to make ion-conducting polymers that can be end-capped. The precursor ion-conducting oligomer contains two leaving groups (e.g. fluorine (F)) while the other three components contain leaving groups and/or displacement groups (e.g. hydroxyl (—OH)). Sulfur linkages can be formed by replacing —OH with thiol (—SH). The leaving group F on the ion conducing oligomer can be replaced with a displacement group in which case the other precursors are modified to substitute leaving groups for displacement groups and/or to substitute displacement groups for leaving groups.

TABLE 1
Exemplary Leaving Groups (Fluorine) and
Displacement Group (OH) Combinations

| Precursor Ion- | Precursor | Precursor Ion- | Precursor |
|---|---|---|---|
| conducting | Non Ionic | conducting | Non Ionic |
| Oligomer | Oligomer | Momomer | Monomer |
| 1) F | OH | OH | OH |
| 2) F | F | OH | OH |
| 3) F | OH | F | OH |
| 4) F | OH | OH | F |
| 5) F | F | F | OH |
| 6) F | F | OH | F |
| 7) F | OH | F | F |

Preferred combinations of precursors for ion conducting polymers are set forth in lines 5 and 6 of Table 1.

When the ion-conducting oligomer is not present, the preferred combination of precursor non-ionic oligomers, precursor ion-conducting monomers and precursor non-ionic monomers is set forth in lines 2-7 of Table 1. Other combinations of the different components are apparent.

The relative amounts of precursors can be chosen so that two leaving groups or displacement groups are present at the end of the polymer so that both ends can be capped if sufficient end capping monomer or oligomer are present. Alternatively, the relative amounts of precursors can be chosen so that the polymer has one leaving group at one end and one displacement group at the other end so that one terminus is end capped with a monomer or oligomer that contains a leaving group or a displacement group.

The ion-conductive copolymer may be represented by Formula I:
R₁—[—(Ar₁-T-)ᵢ-Ar₁—X—]ₐ^{m}/(—Ar₂—U—Ar₂—X—)_{b}ⁿ/[—(Ar₃—V—)ⱼ—Ar₃—X—]_{c}^{o}/(—Ar₄—W—Ar₄—X—)_{d}^{p}/]—R₂ Formula I

wherein Ar₁, Ar₂, Ar₃ and Ar₄ are independently the same or different aromatic moieties, at least one of Ar₁ comprises an ion-conducting group; at least one of Ar₂ comprises an ion-conducting group;

T, U, V and W are linking moieties;

X are independently —O— or —S—;

i and j are independently integers greater than 1;

a, b, c, and d are mole fractions wherein the sum of a, b, c and d is 1, a is 0 or greater than 0 and at least one of b, c and d are greater than 0; and

m, n, o, and p are integers indicating the number of different oligomers or monomers in the copolymer.

R₁ and R₂ are end-capping monomers and/or oligomers where at least one of R₁ and R₂ is present in said copolymer.

The preferred values of a, b, c, and d, i and j as well as m, n, o, and p are set forth below.

The ion-conducting copolymer may also be represented by Formula II:
R₁—[[—(Ar₁-T-)ᵢ-Ar₁—X—]ₐ^{m}/(—Ar₂—U—Ar₂—X—)_{b}ⁿ/[—(Ar₃—V—)ⱼ—Ar₃—X—]_{c}^{o}/(—Ar₄—W—Ar₄—X—)_{d}^{p}/]—R₂ Formula II

wherein Ar₁, Ar₂, Ar₃ and Ar₄ are independently phenyl, substituted phenyl, napthyl, terphenyl, aryl nitrile and substituted aryl nitrile;

at least one of Ar₁ comprises an ion-conducting group;

at least one of Ar₂ comprises an ion-conducting group;

T, U, V and W are independently a bond, —C(O)—,

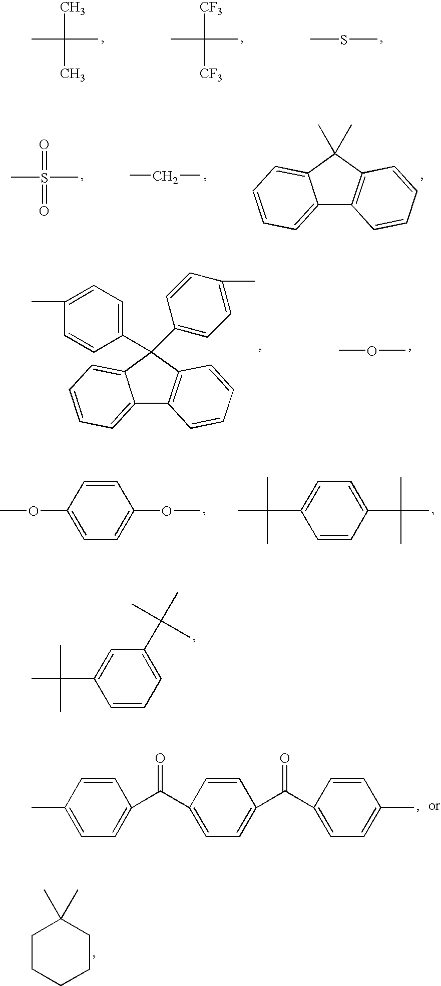

X are independently —O— or —S—;

i and j are independently integers greater than 1; and

a, b, c, and d are mole fractions wherein the sum of a, b, c and d is 1, a is 0 or greater than 0 and at least one of b, c and d are greater than 0; and

m, n, o, and p are integers indicating the number of different oligomers or monomers in the copolymer.

R₁ and R₂ are end-capping monomers and/or oligomers where at least one of and R₁ and R₂ is present in said copolymer.

The ion-conductive copolymer can also be represented by Formula III:
R₁—[[—(Ar₁-T-)ᵢ-Ar₁—X—]ₐ^{m}/(—Ar₂—U—Ar₂—X—)_{b}ⁿ/[—(Ar₃—V—)ⱼ—Ar₃—X—]_{c}^{o}/(—Ar₄—W—Ar₄—X—)_{d}^{p}/]—R₂ Formula III

wherein Ar₁, Ar₂, Ar₃ and Ar₄ are independently phenyl, substituted phenyl, napthyl, terphenyl, aryl nitrile and substituted aryl nitrile;

at least one of Ar₁ comprises an ion-conducting group;

at least one of Ar₂ comprises an ion-conducting group;

at least one where T, U, V and W are independently a bond O, S, C(O), S(O₂), alkyl, branched alkyl, fluoroalkyl, branched fluoroalkyl, cycloalkyl, aryl, substituted aryl or heterocycle;

X are independently —O— or —S—;

i and j are independently integers greater than 1;

a, b, c, and d are mole fractions wherein the sum of a, b, c and d is 1, a is 0 or greater than 0 and at least two of b, c and d are greater than 0; and

m, n, o, and p are integers indicating the number of different oligomers or monomers in the copolymer.

R₁ and R₂ are end-capping monomers and/or oligomers where at least one of the R₁ and R₂ is present in said copolymer.

In each of the forgoing formulas I, II and III [—(Ar₁-T-)ᵢ—Ar₁—]ₐ^{m} is an ion-conducting oligomer; (—Ar₂—U—Ar₂—)_{b}ⁿ is an ion-conducting monomer; [(—Ar₃—V—)ⱼ—Ar₃—]_{c}^{o} is a non-ionic oligomer; and (—Ar₄—W—Ar₄—)_{d}^{p} is a non-ionic monomer. Accordingly, these formulas are directed to ion-conducting polymers that include ion-conducting oligomer(s) in combination at least two of the following: (1) one or more ion conductive monomers, (2) one or more non-ionic monomers and (3) one or more non-ionic oligomers.

When the ion conducting oligomer is not present, these formulas are directed to ion-conducting polymers that include at least two of the following: (1) one or more ion conductive monomers, (2) one or more non-ionic monomers and (3) one or more non-ionic oligomers. Preferred combinations are of (1 and 2) and (1 and 3).

In preferred embodiments, i and j are independently from 2 to 12, more preferably from 3 to 8 and most preferably from 4 to 6.

The mole fraction “a” of ion-conducting oligomer in the copolymer is zero or greater than zero e.g. between 0.3 and 0.9, more preferably from 0.3 to 0.7 and most preferably from 0.3 to 0.5.

The mole fraction “b” of ion-conducting monomer in the copolymer is preferably from 0 to 0.5, more preferably from 0.1 to 0.4 and most preferably from 0.1 to 0.3.

The mole fraction of “c” of non-ionic oligomer is preferably from 0 to 0.3, more preferably from 0.1 to 0.25 and most preferably from 0.01 to 0.15.

The mole fraction “d” of non-ionic monomer is preferably from 0 to 0.7, more preferably from 0.2 to 0.5 and most preferably from 0.2 to 0.4.

In some instance, b, c and d are all greater then zero. In other cases, a and c are greater than zero and b and d are zero. In other cases, a is zero, b is greater than zero and at least c or d or c and d are greater than zero. Nitrogen is generally not present in the copolymer backbone.

The indices m, n, o, and p are integers that take into account the use of different monomers and/or oligomers in the same copolymer or among a mixture of copolymers, where m is preferably 1, 2 or 3, n is preferably 1 or 2, o is preferably 1 or 2 and p is preferably 1, 2, 3 or 4.

In some embodiments at least two of Ar₂, Ar₃ and Ar₄ are different from each other. In another embodiment Ar₂, Ar₃ and Ar₄ are each different from the other.

In some embodiments, when there is no hydrophobic oligomer, i.e. when c is zero in Formulas I, II, or III: (1) the precursor ion conductive monomer used to make the ion-conducting polymer is not 2,2′ disulfonated 4,4′ dihydroxy biphenyl; (2) the ion conductive polymer does not contain the ion-conducting monomer that is formed using this precursor ion conductive monomer; and/or (3) the ion-conducting polymer is not the polymer made according to Example 3 herein.

In some embodiments, a and c are zero and b and d are greater than zero in Formulas I, II and III. In this situation, random copolymers are generally made by use of at least three different precursor monomers where at least one is an ion conducting monomer and at least one of the precursor monomers contains a monomer with two leaving groups and at least one of the other two is a monomer with two displacement groups.

Formula IV is an example of a preferred end capped random coplolymer where n and m are mole fractions where n is between 0.5 and 0.9 and m is between 0.1 and 0.5. A preferred ratio is where n is 0.7 and m is 0.3.

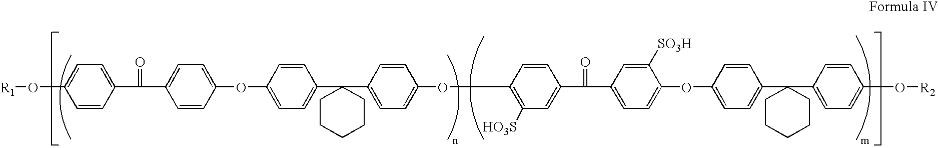

Specific examples of this end capped random copolymer is set forth for the compounds used to make Membranes 1, 4 and 5. The polymers were end-capped by mono-fluorinated monomers (4-fluorobenzophenone F—K, 4-fluorobiphenyl F—B, and 4-fluorobenzonitrile F—CN) where a pre-determined amount of F-monomer was added at the beginning of each polymerization. In these examples the amounts of the precursors were chosen to result in the end capping of primarily one end of the polymer. In these membranes, n and m are as above for Formula IV.

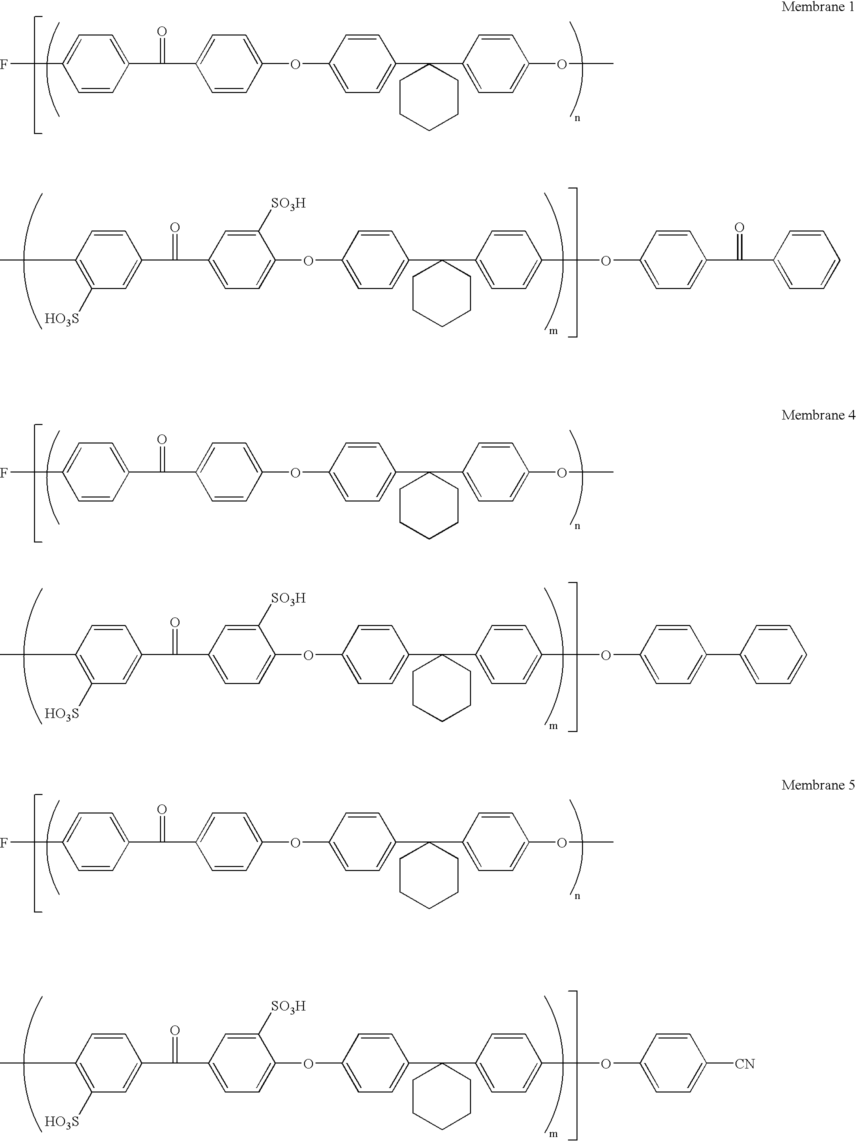

Table 2 discloses some of the monomers used to make ion-conductive copolymers.

TABLE 2

| | | | |
|---|---|---|---|
| | | Molecular | |
| Acronym | Full name | weight | Chemical structure |

1) Precursor Difluoro-end monomers

| | | | |
|---|---|---|---|
| Bis K | 4,4′-Difluorobenzophenone | 218.20 | 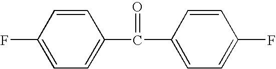 |
| Bis SO₂ | 4,4′-Difluorodiphenylsulfone | 254.25 | 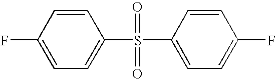 |
| S-Bis K | 3,3′-disulfonated-4,4′- difluorobenzophone | 422.28 | 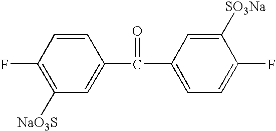 |

2) Precursor Dihydroxy-end monomers

| | | | |
|---|---|---|---|
| Bis AF (AF or 6F) | 2,2-Bis(4-hydroxyphenyl) hexafluoropropane or 4,4′-(hexafluoroisopropylidene) diphenol | 336.24 | 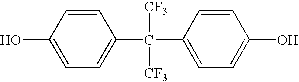 |
| BP | Biphenol | 186.21 | 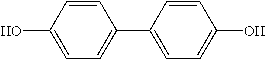 |
| Bis FL | 9,9-Bis(4-hydroxyphenyl)fluorene | 350.41 | 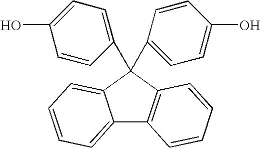 |
| Bis Z | 4,4′-cyclohexylidenebisphenol | 268.36 | 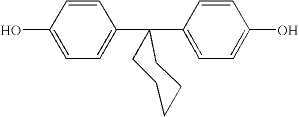 |
| Bis S | 4,4′-thiodiphenol | 218.27 | 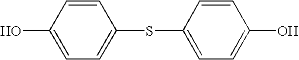 |

3) Precursor Dithiol-end monomers

| | |
|---|---|
| 4,4′-thiol bis benzene thiol | 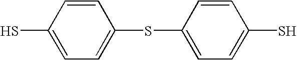 |

The bifunctional precursor monomers and/or oligomers used to make the ion-conducting copolymer can be used as an end-capping monomer or oligomer by removal of one of the leaving or displacement groups. For example, the precursors of R1 and R2 can be: (1) a monovalent ion-conducting oligomer represented by the formulas (Y)—[—(Ar₁-T-)ᵢ-Ar₁]and [(Ar₁-T-)ᵢ-Ar₁—]—(Y); (2) an ion-conducting monomer represented by the formulas (Y)—Ar₂—U—Ar₂) and (Ar₂—U—Ar₂—)—(Y); (3) a non-ionic oligomer represented by the formula (Y)—[(—Ar₃—V—)ⱼ—Ar₃]and [(Ar₃—V—)ⱼ—Ar₃—]—(Y) and (4) a non-ionic oligomer represented by the formula (Y)—(—Ar₄—W—Ar₄) and (Ar₄—W—Ar₄—)—(Y) where Y is a displacement of leaving group and th otrher terms are as set forth for Formulas I, II and III.

For example, the following non-ionic monovalent precursor monomers can be used:

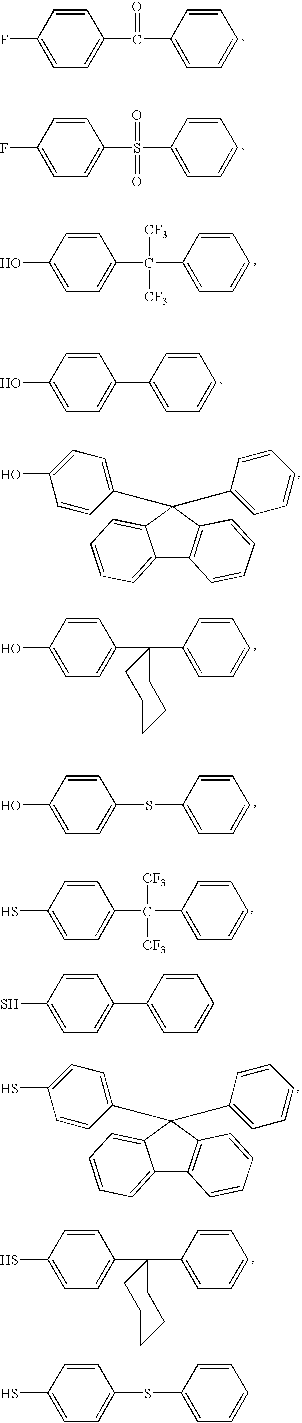

In some embodiments, the monovalent monomer or oligomer can further comprise an ion-conducting group such as sulfonic, phosphonic or carboxylic acids.

The ion conductive copolymers that can be end-capped include the random copolymers disclosed in U.S. patent application Ser. No. 10/438,186, filed May 13, 2003, entitled “Sulfonated Copolymer,” Publication No. US 2004-0039148 A1, published Feb. 26, 2004, and U.S. patent application Ser. No. 10/987,178, filed Nov. 12, 2004, entitled “Ion Conductive Random Copolymer” and the block copolymers disclosed in U.S. patent application Ser. No. 10/438,299, filed May 13, 2003, entitled “Ion Conductive Block Copolymers,” published Jul. 1, 2004, Publication No. 2004-0126666. Other ion conductive copolymers include the oligomeric ion conducting polymers disclosed in U.S. patent application Ser. No. 10/987,951, filed Nov. 12, 2004, Publication No. 2005-0234146, published Oct. 20, 2005, entitled “Ion Conductive Copolymers Containing One or More Hydrophobic Monomers or Oligomers,” U.S. patent application Ser. No. 10/988,187, filed Nov. 11, 2004, Publication No. 2005-0282919, published Dec. 22, 2005, entitled “Ion Conductive Copolymers Containing One or More Hydrophobic Oligomers” and U.S. patent application Ser. No. 11/077,994, filed Mar. 11, 2005, Publication No. 2006-0041100, entitled “Ion Conductive Copolymers Containing One or More Ion conducting Oligomers.” Each of the foregoing are incorporated herein by reference. As with Formulas I, II and III, the non-conductive polymer may be a copolymer having the same backbone as these copolymers without the ion conductive groups.

Other ion-conducting copolymers and the monomers that can be used to make them include those disclosed in U.S. patent application Ser. No. 09/872,770, filed Jun. 1, 2001, Publication No. US 2002-0127454 A1, published Sep. 12, 2002, U.S. patent application Ser. No. 10/351,257, filed Jan. 23, 2003, Publication No. US 2003-0219640 A1, published Nov. 27, 2003, U.S. application Ser. No. 10/449,299, filed Feb. 20, 2003, Publication No. US 2003-0208038 A1, published Nov. 6, 2003, each of which are expressly incorporated herein by reference. Other ion-conducting copolymers that can be end-capped are made for comonomers such as those used to make sulfonated trifluorostyrenes (U.S. Pat. No. 5,773,480), acid-base polymers, (U.S. Pat. No. 6,300,381), poly arylene ether sulfones (U.S. Patent Publication No. US2002/0091225A1); graft polystyrene (Macromolecules 35:1348 (2002)); polyimides (U.S. Pat. No. 6,586,561 and J. Membr. Sci. 160:127 (1999)) and Japanese Patent Applications Nos. JP2003147076 and JP2003055457, each of which are expressly identified herein by reference.

Although the end-capped copolymers of the invention have been described in connection with the use of arylene polymers, the ionic and non-ionic monomers or oligomers need not be arylene but rather may be aliphatic or perfluorinated aliphatic backbones containing ion-conducting groups. Ion-conducting groups may be attached to the backbone or may be pendant to the backbone, e.g., attached to the polymer backbone via a linker. Alternatively, ion-conducting groups can be formed as part of the standard backbone of the polymer. See, e.g., U.S. 2002/018737781, published Dec. 12, 2002 incorporated herein by reference. Any of these ion-conducting oligomers can be used to practice the present invention.

The mole percent of ion-conducting groups when only one ion-conducting group is present is preferably between 30 and 70%, or more preferably between 40 and 60%, and most preferably between 45 and 55%. When more than one conducting group is contained within the ion-conducting monomer, such percentages are multiplied by the total number of ion-conducting groups per monomer. Thus, in the case of a monomer comprising two sulfonic acid groups, the preferred sulfonation is 60 to 140%, more preferably 80 to 120%, and most preferably 90 to 110%. Alternatively, the amount of ion-conducting group can be measured by the ion exchange capacity (IEC). By way of comparison, Nafion® typically has a ion exchange capacity of 0.9 meq per gram. In the present invention, it is preferred that the IEC be between 0.9 and 3.0 meq per gram, more preferably between 1.0 and 2.5 meq per gram, and most preferably between 1.6 and 2.2 meq per gram.

Although the end capped ion conducting copolymers have been described in connection with the use of arylene polymers, end capping can be applied to many other systems. For example, the ionic oligomers, non-ionic oligomers as well as the ionic and non-ionic monomers need not be arylene but rather may be aliphatic or perfluorinated aliphatic backbones containing ion-conducting groups. Ion-conducting groups may be attached to the backbone or may be pendant to the backbone, e.g., attached to the polymer backbone via a linker. Alternatively, ion-conducting groups can be formed as part of the standard backbone of the polymer. See, e.g., U.S. 2002/018737781, published Dec. 12, 2002 incorporated herein by reference. Any of these ion-conducting oligomers can be used to practice the present invention.

Polymer membranes may be fabricated by solution casting of the ion-conductive copolymer. When cast into a membrane for use in a fuel cell, it is preferred that the membrane thickness be between 0.1 to 10 mils, more preferably between 1 and 6 mils, most preferably between 1.5 and 2.5 mils.

As used herein, a membrane is permeable to protons if the proton flux is greater than approximately 0.005 S/cm, more preferably greater than 0.01 S/cm, most preferably greater than 0.02 S/cm.

As used herein, a membrane is substantially impermeable to methanol if the methanol transport across a membrane having a given thickness is less than the transfer of methanol across a Nafion membrane of the same thickness. In preferred embodiments the permeability of methanol is preferably 50% less than that of a Nafion membrane, more preferably 75% less and most preferably greater than 80% less as compared to the Nafion membrane.

After the ion-conducting copolymer has been formed into a membrane, it may be used to produce a catalyst coated membrane (CCM). As used herein, a CCM comprises a PEM when at least one side and preferably both of the opposing sides of the PEM are partially or completely coated with catalyst. The catalyst is preferable a layer made of catalyst and ionomer. Preferred catalysts are Pt and Pt—Ru. Preferred ionomers include Nafion and other ion-conductive polymers. In general, anode and cathode catalysts are applied onto the membrane using well established standard techniques. For direct methanol fuel cells, platinum/ruthenium catalyst is typically used on the anode side while platinum catalyst is applied on the cathode side. For hydrogen/air or hydrogen/oxygen fuel cells platinum or platinum/ruthenium is generally applied on the anode side, and platinum is applied on the cathode side. Catalysts may be optionally supported on carbon. The catalyst is initially dispersed in a small amount of water (about 100 mg of catalyst in 1 g of water). To this dispersion a 5% ionomer solution in water/alcohol is added (0.25-0.75 g). The resulting dispersion may be directly painted onto the polymer membrane. Alternatively, isopropanol (1-3 g) is added and the dispersion is directly sprayed onto the membrane. The catalyst may also be applied onto the membrane by decal transfer, as described in the open literature (Electrochimica Acta, 40: 297 (1995)).

The CCM is used to make MEA's. As used herein, an MEA refers to an ion-conducting polymer membrane made from a CCM according to the invention in combination with anode and cathode electrodes positioned to be in electrical contact with the catalyst layer of the CCM.

The electrodes are in electrical contact with the catalyst layer, either directly or indirectly via a gas diffusion or other conductive layer, so that they are capable of completing an electrical circuit which includes the CCM and a load to which the fuel cell current is supplied. More particularly, a first catalyst is electrocatalytically associated with the anode side of the PEM so as to facilitate the oxidation of hydrogen or organic fuel. Such oxidation generally results in the formation of protons, electrons and, in the case of organic fuels, carbon dioxide and water. Since the membrane is substantially impermeable to molecular hydrogen and organic fuels such as methanol, as well as carbon dioxide, such components remain on the anodic side of the membrane. Electrons formed from the electrocatalytic reaction are transmitted from the anode to the load and then to the cathode. Balancing this direct electron current is the transfer of an equivalent number of protons across the membrane to the cathodic compartment. There an electrocatalytic reduction of oxygen in the presence of the transmitted protons occurs to form water. In one embodiment, air is the source of oxygen. In another embodiment, oxygen-enriched air or oxygen is used.

The membrane electrode assembly is generally used to divide a fuel cell into anodic and cathodic compartments. In such fuel cell systems, a fuel such as hydrogen gas or an organic fuel such as methanol is added to the anodic compartment while an oxidant such as oxygen or ambient air is allowed to enter the cathodic compartment. Depending upon the particular use of a fuel cell, a number of cells can be combined to achieve appropriate voltage and power output. Such applications include electrical power sources for residential, industrial, commercial power systems and for use in locomotive power such as in automobiles. Other uses to which the invention finds particular use includes the use of fuel cells in portable electronic devices such as cell phones and other telecommunication devices, video and audio consumer electronics equipment, computer laptops, computer notebooks, personal digital assistants and other computing devices, GPS devices and the like. In addition, the fuel cells may be stacked to increase voltage and current capacity for use in high power applications such as industrial and residential sewer services or used to provide locomotion to vehicles. Such fuel cell structures include those disclosed in U.S. Pat. Nos. 6,416,895, 6,413,664, 6,106,964, 5,840,438, 5,773,160, 5,750,281, 5,547,776, 5,527,363, 5,521,018, 5,514,487, 5,482,680, 5,432,021, 5,382,478, 5,300,370, 5,252,410 and 5,230,966.

Such CCM and MEM's are generally useful in fuel cells such as those disclosed in U.S. Pat. Nos. 5,945,231, 5,773,162, 5,992,008, 5,723,229, 6,057,051, 5,976,725, 5,789,093, 4,612,261, 4,407,905, 4,629,664, 4,562,123, 4,789,917, 4,446,210, 4,390,603, 6,110,613, 6,020,083, 5,480,735, 4,851,377, 4,420,544, 5,759,712, 5,807,412, 5,670,266, 5,916,699, 5,693,434, 5,688,613, 5,688,614, each of which is expressly incorporated herein by reference.

The CCM's and MEA's of the invention may also be used in hydrogen fuel cells that are known in the art. Examples include U.S. Pat. Nos. 6,630,259; 6,617,066; 6,602,920; 6,602,627; 6,568,633; 6,544,679; 6,536,551; 6,506,510; 6,497,974, 6,321,145; 6,195,999; 5,984,235; 5,759,712; 5,509,942; and 5,458,989 each of which are expressly incorporated herein by reference.

The ion-conducting polymer membranes of the invention also find use as separators in batteries. Particularly preferred batteries are lithium ion batteries.

### EXAMPLES

I. Random Copolymerizations

In the current study, the molar % of the mono-fluorinated monomer used to end-cap the random copolymer BisZ (i.e., mole % of the non-flourinated monomers) was adjusted to 1 mol %, 2 mol %, and 5 mol % for F—K, and I mol % both for F—B and F—CN, to ensure that OH end groups can be fully end-capped.

### Comparative 1

In a 500 mL three necked round flask, equipped with a mechanical stirrer, a thermometer probe connected with a nitrogen inlet, and a Dean-Stark trap/condenser, 4,4′-difluorobenzophenone (BisK, 19.09 g, 0.0875 mol), 3,3′-disulfonated-4,4′-difluorobenzophenone (SBisK, 15.84 g, 0.0375 mol), 1,1-bis(4-hydroxyphenyl)cyclohexane (33.54 g, 0.125 mol), and anhydrous potassium carbonate (22.46 g, 0.165 mol), 225 mL of DMSO and 112 mL of Toluene. The reaction mixture was slowly stirred under a slow nitrogen stream. After heating at ˜85° C. for 1 h and at ˜120° C. for 1.5 h, the reaction temperature was raised to 140° C. for 1.5 h, and at 155° C. for 1 h, finally to 170° C. for 2 h. After cooling to 70° C. with continuing stirring, the solution was dropped into 2 L of cooled methanol with a vigorous stirring. The precipitates were filtrated and washed with Di-water four times and dried at 80° C. for one day. The sodium form polymer was exchanged to acid form by washing the polymer in hot sulfuric acid solution (1.5 M) twice (1 h each) and in cold di-water twice. The polymer was then dried at 80° C. overnight and at 80° C. under vacuum for additional day. This polymer has an inherent viscosity of 1.20 dl/g in DMAc (0.25 g/dl).

### Example 1 with 1 mol % Endcapper 4-fluorobenzophenone

This polymer was synthesized in a similar way as described in comparative 1, using following compositions: 4,4′-difluorobenzophenone (BisK, 19.09 g, 0.0875 mol), 3,3′-disulfonated-4,4′-difluorobenzophenone (SBisK, 15.84 g, 0.0375 mol), 1,1-bis(4-hydroxyphenyl)cyclohexane (33.54 g, 0.125 mol), 4-fluorobenzophenone (F—K, 0.25 g, 0.00125 mol), and anhydrous potassium carbonate (22.46 g, 0.165 mol), 225 mL of DMSO and 112 mL of Toluene. This polymer after acid treatment has an inherent viscosity of 0.98 dl/g in DMAc (0.25 g/dl).

### Example 2 with 2 mol % Endcapper 4-fluorobenzophenone

This polymer was synthesized in a similar way as described in comparative 1, using following compositions: 4,4′-difluorobenzophenone (BisK, 19.09 g, 0.0875 mol), 3,3′-disulfonated-4,4′-difluorobenzophone (SBisK, 15.84 g, 0.0375 mol), 1,1-bis(4-hydroxyphenyl)cyclohexane (33.54 g, 0.125 mol), 4-fluorobenzophenone (F—K, 0.50 g, 0.0025 mol), and anhydrous potassium carbonate (22.46 g, 0.165 mol), 225 mL of DMSO and 112 mL of Toluene. This polymer after acid treatment has an inherent viscosity of 0.90 dl/g in DMAc (0.25 g/dl).

### Example 3 with 5 mol % Endcapper 4-fluorobenzophenone

This polymer was synthesized in a similar way as described in comparative 1, using following compositions: 4,4′-difluorobenzophenone (BisK, 19.09 g, 0.0875 mol), 3,3′-disulfonated-4,4′-difluorobenzophenone (SBisK, 15.84 g, 0.0375 mol), 1,1-bis(4-hydroxyphenyl)cyclohexane (33.54 g, 0.125 mol), 4-fluorobenzophenone (F—K, 1.25 g, 0.00625 mol), and anhydrous potassium carbonate (22.46 g, 0.165 mol), 225 mL of DMSO and 112 mL of Toluene. This polymer after acid treatment has an inherent viscosity of 0.42 dl/g in DMAc (0.25 g/dl).

### Example 4 with 1 mol % Endcapper 4-biphenyl

This polymer was synthesized in a similar way as described in comparative 1, using following compositions: 4,4′-difluorobenzophenone (BisK, 19.09 g, 0.0875 mol), 3,3′-disulfonated-4,4′-difluorobenzophenone (SBisK, 15.84 g, 0.0375 mol), 1,1-bis(4-hydroxyphenyl)cyclohexane (33.54 g, 0.125 mol), 4-fluorobiphenyl (0.215 g, 0.00125 mol), and anhydrous potassium carbonate (22.46 g, 0.165 mol), 225 mL of DMSO and 112 mL of Toluene. This polymer after acid treatment has an inherent viscosity of 1.18 dl/g in DMAc (0.25 g/dl).

### Example 5 with 1 mol % Endcapper 4-fluorobenzonitrile

This polymer was synthesized in a similar way as described in comparative 1, using following compositions: 4,4′-difluorobenzophenone (BisK, 19.09 g, 0.0875 mol), 3,3′-disulfonated-4,4′-difluorobenzophenone (SBisK, 15.84 g, 0.0375 mol), 1,1-bis(4-hydroxyphenyl)cyclohexane (33.54 g, 0.125 mol), 4-fluorobenzonitrile (0.154 g, 0.00125 mol), and anhydrous potassium carbonate (22.46 g, 0.165 mol), 225 mL of DMSO and 112 mL of Toluene. This polymer after acid treatment has an inherent viscosity of 1.18 dl/g in DMAc (0.25 g/dl).

Results

Table 3 summarizes data on polymer 1-5 made according to Examples 1-5. With introduction of 1 mol % end-capping monomers, the polymers synthesized have good molecular weights. As expected, the polymer end-capped with 5 mol % F—K has a very low molecular weight due to the imbalanced stoichiometry. A close look on the Z-K series reveals that these polymers have good polydispersities (<2.3), whereas the non-encapped comparative example 1 has a PDI of 2.8.

TABLE 3
Characterization of End-capping random polymers

| | | | Mn/Mw/Mz/ | Mn/Mw/Mz/ |
|---|---|---|---|---|
| | I.V. | | PDI Polymer | PDI Polymer |
| | Na form/ | IEC | Na form | acid form |
| Polymer | acid form | Polymer | 10⁴/10⁴/10⁴/— | 10⁴/10⁴/10⁴/— |
| Polymer 1 | 1.16/1.05 | 1.15 | 4.86/11.08/ | 4.52/9.53/ |
| | | | 23.27/2.28 | 18.82/2.11 |
| Polymer 2 | 1.05./1.02 | 1.14 | 4.31/9.36/ | 4.30/8.76/ |
| | | | 19.21/2.17 | 17.69/2.04 |
| Polymer 3 | 0.42/NA | NA | 1.76/2.72/ | NA |
| | | | 4.61/1.55 | |
| Polymer 4 | 1.30/1.15 | 1.15 | N/A | N/A |
| Polymer 5 | 1.42/1.20 | 1.15 | N/A | N/A |

The end-capped polymers except polymer 3 (due to its low molecular weight) were cast into membranes from DMAc solutions. Table 4 summarizes ex-situ data from these membranes. Reduced I.V.s and IECs from polymers to membranes were observed in almost all cases, indicating there was some degradation during coating process. However, the degree of these losses is less than that of the non-end-capped membrane. MEAs were also fabricated from some of these membranes for DMFC testing. With 1 M methanol concentration and operation temperature at 60 C, MEA 1 from membrane 1 has a power density at 138 mW/cm2 at 0.4 V, and methanol crossover of 46 mA/cm2, whereas comparative membrane 1 has a power at 124 mW/cm2 and a crossover of 53 mA/cm2.

TABLE 4
Membrane Ex-Situ Data Summary

| | I.V. | IEC | Water | Swell- | Conductivity |
|---|---|---|---|---|---|
| | Polymer/ | Polymer/ | Uptake | ing | 60 C./Boiled |
| Membrane | Membrane | Membrane | (%) | (%) | (S/cm) |
| Membrane 1 | 0.98/0.98 | 1.16/0.99 | 23.9 | 28.5 | 0.018/0.031 |
| Membrane 2 | 0.90/0.88 | 1.16/NA | 23.9 | 29.0 | 0.017/0.030 |
| Membrane 4 | 1.18/1.14 | 1.15/1.05 | 24.3 | 29.5 | 0.022/0.032 |
| Membrane 5 | 1.18/1.15 | 1.15/1.05 | 23.5 | 28.5 | 0.021/0.032 |
| Comparative 1 | 1.20/1.10 | 1.13/0.98 | 22.4 | 30.0 | 0.017/0.034 |

Ex-situ data for end-capped membranes 6-9 and comparative 2 are summarized in Table 5. Both membranes 7 and 8 have higher swelling, due to lower molecular weights. Membranes 6 and 9 have comparable performance to comparative 2. These membranes are fabricated into MEAs and they show good performance in H2/Air fuel cell operation.

TABLE 5
Membrane Ex-Situ Data Summary

| | | | Water | | Conductivity |
|---|---|---|---|---|---|
| | I.V. | IEC | Uptake | Swelling | 60 C./Boiled |
| Membrane | Polymer | Polymer | (%) | (%) | (S/cm) |
| Membrane 6 | 1.64 | 2.15 | 58 | 53 | 0.118/0.122 |
| Membrane 7 | 1.00 | 1.93 | 166 | 130 | 0.098/0.075 |
| Membrane 8 | 1.57 | 1.88 | 166 | 125 | 0.099/0.072 |
| Membrane 9 | 2.06 | 2.08 | 72 | 53 | 0.087/0.100 |
| Comparative 2 | 1.79 | 2.15 | 71 | 51 | 0.110/0.120 |

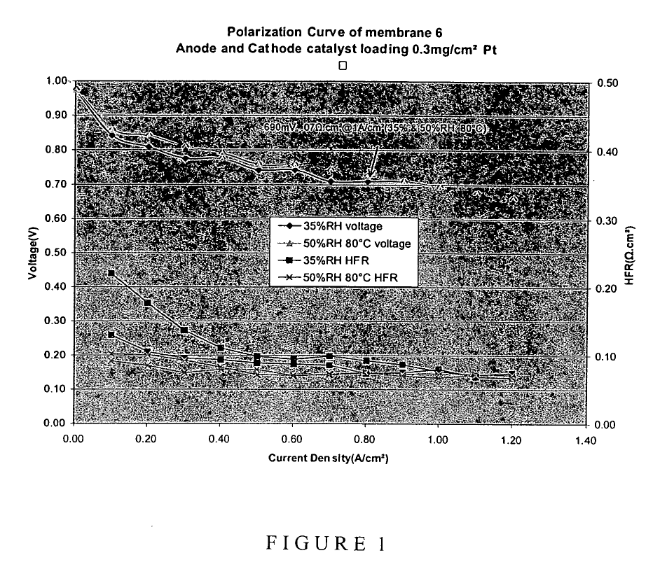

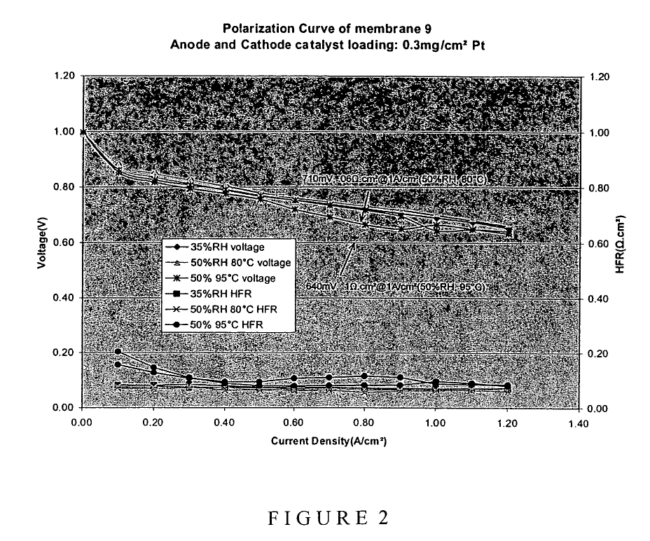

The polarization curves for Membranes 6 and 9 are set forth in FIG. 1 and FIG. 2.

II. Block Copolymerizations

Oligomer 1 with Fluoride Ending Groups:

In a 500 mL three necked round flask, equipped with a mechanical stirrer, a thermometer probe connected with a nitrogen inlet, and a Dean-Stark trap/condenser, 4,4′-difluorobenzophone (BisK, 28.36 g, 0.13 mol), 4,4′-dihydroxytetraphenylmethane (34.36 g, 0.0975 mol), and anhydrous potassium carbonate (17.51 g, 0.169 mol), 234 mL of DMSO and 117 mL of Toluene. The reaction mixture was slowly stirred under a slow nitrogen stream. After heating at ˜85° C. for 1 h and at ˜120° C. for 1 h, the reaction temperature was raised to ˜135° C. for 3 h, and finally to ˜170° C. for 2 h. After cooling to ˜70° C. with continuing stirring, the solution was dropped into 2 L of cooled methanol with a vigorous stirring. The precipitates were filtrated and washed with Di-water four times and dried at 80° C. for one day and at 80° C. under a vacuum oven for 2 days.

Oligomer 2 with Fluoride Ending Groups

This oligomer was synthesized in a similar way as described in oligomer 1, using following compositions: bis(4-fluorophenyl)sulfone (63.56 g, 0.25 mol), 4,4′-dihydroxytetraphenylmethane (66.08 g, 0.1875 mol), and anhydrous potassium carbonate (33.67 g, 0.325 mol), 450 mL of DMSO and 225 mL of Toluene.

### Comparative 2

In a 500 mL three necked round flask, equipped with a mechanical stirrer, a thermometer probe connected with a nitrogen inlet, and a Dean-Stark trap/condenser, 3,3′-disulfonated-4,4′-difluorobenzophenone (SBisK, 25.42 g), Oligomer 1 (22.93 g), 4,4′-biphenol (13.03 g), and anhydrous potassium carbonate (12.58 g), were added together with a mixture of anhydrous DMSO (234 mL) and freshly distilled toluene (117 mL). The reaction mixture was slowly stirred under a slow nitrogen stream. After heating at 85° C. for 1 h and at 120° C. for 1 h, the reaction temperature was raised to 140° C. for 2 h, and finally to 163° C. for 2 h. After cooling to ˜70° C. with continuing stirring, the viscous solution was dropped into IL of cooled methanol with a vigorous stirring. The noodle-like precipitates were cut and washed with di-water four times and dried at 80° C. overnight. The sodium form polymer was exchanged to acid form by washing the polymer in hot sulfuric acid solution (1.5 M) twice (1 h each) and in cold di-water twice. The polymer was then dried at 80° C. overnight and at 80° C. under vacuum for 2 days. This polymer has an inherent viscosity of 1.79 dl/g in DMAc (0.25 g/dl).

### Example 6 End-Capped with 2.2 mol % 4-fluorobiphenyl

This polymer was synthesized in a similar way as described in comparative 2, using following compositions: 3,3′-disulfonated-4,4′-difluorobenzophenone (SBisK, 25.42 g), Oligomer 1 (22.93 g), 4,4′-biphenol (13.03 g), 4-fluorobiphenyl (0.265 g), and anhydrous potassium carbonate (12.58 g), were added together with a mixture of anhydrous DMSO (234 mL) and freshly distilled toluene (117 mL). This polymer after acid treatment has an inherent viscosity of 1.64 dl/g in DMAc (0.25 g/dl).

### Example 7 End-Capped with 2.2 mol % 4-fluorobiphenyl

This polymer was synthesized in a similar way as described in comparative 2, using following compositions: 3,3′-disulfonated-4,4′-difluorobenzophenone (SBisK, 22.30 g), Oligomer 1 (16.85 g), 4,4′-(hexafluoroisopropylidene)diphenol (20.37 g), 4-fluorobiphenyl (0.227 g), and anhydrous potassium carbonate (10.83 g), were added together with a mixture of anhydrous DMSO (228 mL) and freshly distilled toluene (114 mL). This polymer after acid treatment has an inherent viscosity of 1.00 dl/g in DMAc (0.25 g/dl).

### Example 8 End-Capped with 2.2 mol % 4-fluorobiphenyl

This polymer was synthesized in a similar way as described in comparative 2, using following compositions: 3,3′-disulfonated-4,4′-difluorobenzophenone (SBisK, 22.30 g), Oligomer 2 (18.15 g), 4,4′-(hexafluoroisopropylidene)diphenol (20.37 g), 4-fluorobiphenyl (0.227 g), and anhydrous potassium carbonate (10.83 g), were added together with a mixture of anhydrous DMSO (234 mL) and freshly distilled toluene (117 mL). This polymer after acid treatment has an inherent viscosity of 1.57 dl/g in DMAc (0.25 g/dl).

### Example 9 End-Capped with 2.2 mol % 4-fluorobiphenyl

This polymer was synthesized in a similar way as described in comparative 2, using following compositions: 3,3′-disulfonated-4,4′-difluorobenzophenone (SBisK, 21.79 g), Oligomer 2 (21.17 g), 4,4′-biphenol (11.28 g), 4-fluorobiphenyl (0.227 g), and anhydrous potassium carbonate (10.83 g), were added together with a mixture of anhydrous DMSO (228 mL) and freshly distilled toluene (114 mL). This polymer after acid treatment has an inherent viscosity of 2.06 dl/g in DMAc (0.25 g/dl).

### Example 10 with 0.25 mol % End Capper 4-t-butylphenol

This polymer was synthesized in a similar way as described in comparative 1, using following compositions: 4,4′-difluorobenzophenone (BisK, 19.09 g, 0.0875 mol), 3,3′-disulfonated-4,4′-difluorobenzophenone (SBisK, 15.84 g, 0.0375 mol), 1,1-bis(4-hydroxyphenyl)cyclohexane (32.70 g), 4-t-butylphenol (0.469 g), and anhydrous potassium carbonate (22.46 g, 0.165 mol), 225 mL of DMSO and 112 mL of Toluene. This polymer after acid treatment has an inherent viscosity of 1.26 dl/g in DMAc (0.25 g/dl). Its membrane swelling is 19.5%, water uptake is 21%, conductivity is 0.018 S/cm at 60 C and 0.031 S/cm after boiled, respectively.

What is claimed is:

1. An end capped ion conductive copolymer having the formula
R₁—[[(—Ar₁-T-)ᵢ—Ar₁—X—]ₐ^{m}/(—Ar₂—U—Ar₂—X—)_{b}ⁿ/[(—Ar₃—V—)ⱼ—Ar₃—X—]_{c}^{o}/(—Ar₄—W—Ar₄—X—)_{d}^{p}/]—R₂
wherein Ar₁, Ar₂, Ar₃ and Ar₄ are aromatic moieties;
at least one of Ar₁ comprises an ion-conducting group;
at least one of Ar₂ comprises an ion-conducting group;
T, U, V and W are linking moieties;
X are independently —O— or —S—;
i and j are independently integers greater than 1;
a, b, c, and d are mole fractions wherein the sum of a, b, c and d is 1, a is zero or greater than 0 and at least two of b, c and d is greater than 0;
m, n, o, and p are integers indicating the number of different oligomers or monomers in the copolymer; and
R₁ and R₂ are end-capping monomers and/or oligomers where at least one of R₁ and R₂ is present in said copolymer.

2. The end capped ion-conductive copolymer of claim 1 wherein:
Ar₁, Ar₂, Ar₃ and Ar₄ are independently phenyl, substituted phenyl, napthyl, terphenyl, aryl nitrile and substituted aryl nitrile; and
T, U, V and W are independently a bond O, S, C(O), S(O₂), alkyl, branched alkyl, fluoroalkyl, branched fluoroalkyl, cycloalkyl, aryl, substituted aryl or heterocycle.

3. The end capped ion-conductive copolymer of claim 1 wherein:
Ar₁, Ar₂, Ar₃ and Ar₄ are independently phenyl, substituted phenyl, napthyl, terphenyl, aryl nitrile and substituted aryl nitrile; and
T, U, V and W are independently a bond, —C(O)—,

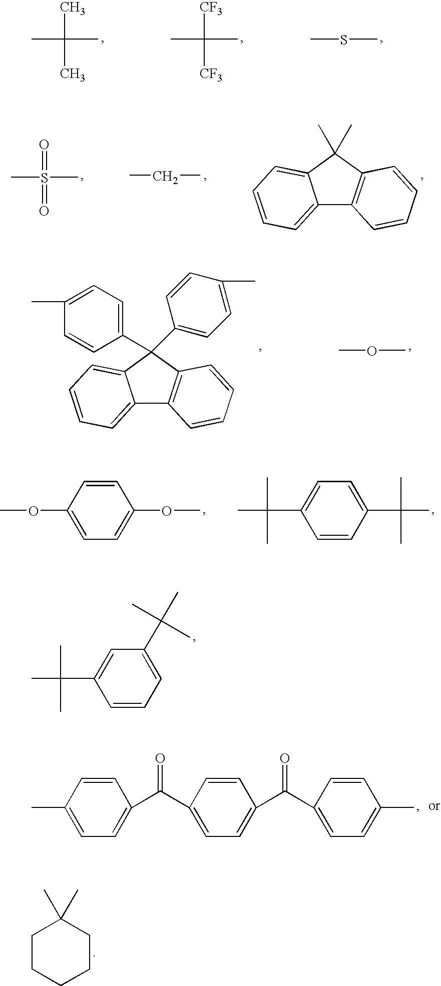

4. An end capped ion conducting polymer having the formula 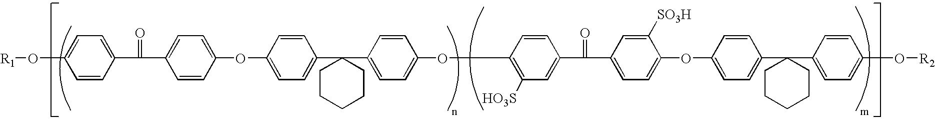
wherein m and n are mole fractions; R₁ and R₂ are end-capping monomers and/or oligomers and at least one of R₁ and R₂ is present in said copolymer.

5. A polymer electrolyte membrane (PEM) comprising the ion-conducting copolymer of claim 1 or 4.

6. A catalyst coated membrane (CCM) comprising the PEM of claim 5 wherein all or part of at least one opposing surface of said PEM comprises a catalyst layer.

7. A membrane electrode assembly (MEA) comprising the CCM of claim 6.

8. A fuel cell comprising the MEA of claim 7.

9. The fuel cell of claim 8 comprising a hydrogen fuel cell.

10. An electronic device comprising the fuel cell of claim 8.

11. A power supply comprising the fuel cell of claim 8.

12. An electric motor comprising the fuel cell of claim 8.

13. A vehicle comprising the electric motor of claim 12.
